(19) United States
(12) Patent Application Publication
(10) Pub. No.: US 2025/0186892 A1
(43) Pub. Date: Jun. 12, 2025

(54) VIRTUAL OBJECT SPAWNING METHOD, APPARATUS, DEVICE AND STORAGE MEDIUM

(71) Applicant: Tencent Technology (Shenzhen) Company Limited, Shenzhen (CN)

(72) Inventor: Zhidong Wang, Shenzhen (CN)

(21) Appl. No.: 19/062,481

(22) Filed: Feb. 25, 2025

Related U.S. Application Data
(63) Continuation of application No. PCT/CN2024/071807, filed on Jan. 11, 2024.

(30) Foreign Application Priority Data
Mar. 2, 2023 (CN) 2023102453804

(51) Int. Cl. A63F 13/58

(52) U.S. Cl. CPC A63F 13/58

(57) ABSTRACT

A virtual object spawning method and apparatus, a device, and a storage medium are disclosed, and pertain to the field of computer technologies. The method includes: obtaining a first processing command, the first processing command corresponding to a first distance threshold and a spawn location, the first distance threshold being configured for triggering spawning of a first virtual object in a virtual environment, and the spawn location being a location configured for spawning the first virtual object in the virtual environment; determining a first distance between a main control virtual object and the spawn location; and processing the first processing command in response to the first distance meeting the first distance threshold, to spawn the first virtual object in the virtual environment. The foregoing method, apparatus, device, and storage medium implement independent and precise control over spawning of a virtual object, and improve accuracy of displaying the virtual object. This helps improve interaction experience of an interaction object, and further ncrease a human-computer interaction rate.

### RELATED APPLICATION

This application is a continuation application of PCT Application PCT/CN2024/071807, filed Jan. 11, 2024, which claims priority to Chinese Patent Application No. 202310245380.4, filed on May 20, 2022, each entitled “VIRTUAL OBJECT SPAWNING METHOD AND APPARATUS, DEVICE, AND STORAGE MEDIUM”, and each which is incorporated herein by reference in its entirety.

### FIELD

This application relates to the field of computer technologies, and in particular, to a virtual object spawning method, apparatus, device, and storage medium.

### BACKGROUND

In an application supporting a virtual environment, a user may control a main control virtual object to move freely in the virtual environment. For example, the application supporting the virtual environment may be an open big world game, and the virtual environment may be a big world map.

During movement of the main control virtual object controlled by the user in the virtual environment, other virtual objects belonging to the virtual environment are spawned. For example, a non-player character (NPC) is spawned. In the related art, by using a location of a main control virtual object as a center block of nine blocks, a game server queries whether a virtual object in another block in a virtual environment has been spawned in the virtual environment. If a virtual object located in another block in the virtual environment has not been spawned in the virtual environment, the game server controls a client to spawn the virtual object.

### SUMMARY

A virtual object spawning method, apparatus, device, and storage medium are provided herein, to independently and precisely control spawning of a virtual object, and improve accuracy of displaying the virtual object. Technical solutions are provided below. For example, a first virtual object that has not been spawned may be spawned based on a distance between a main control virtual object and a spawn location of the first virtual object in a virtual environment. In this way, spawning of each virtual object around the main control virtual object can be separately and precisely controlled, to improve accuracy of displaying the virtual object. Even in a scenario in which virtual objects need to be frequently spawned, display effect of the virtual objects can be ensured, to improve interaction experience of an interaction object and further increase a human-computer interaction rate.

A virtual object spawning method provided herein may comprise:
obtaining a first processing command, the first processing command corresponding to a first distance threshold and a spawn location, the first distance threshold indicating a triggering condition for spawning of a first virtual object in a virtual environment, and the spawn location indicating a location for spawning the first virtual object in the virtual environment;
determining a first distance between a main control virtual object and the spawn location; and
spawning the first virtual object in the virtual environment by processing the first processing command, wherein the spawning is based on a determination that the first distance meets the first distance threshold.

A virtual object spawning apparatus provided herein may comprise one or more processors and memory storing computer-readable instructions that when executed by the one or more processors, cause the apparatus to:
obtain a first processing command, the first processing command corresponding to a first distance threshold and a spawn location, the first distance threshold indicating a triggering condition for spawning of a first virtual object in a virtual environment, and the spawn location indicating a location for spawning the first virtual object in the virtual environment;
determine a first distance between a main control virtual object and the spawn location; and
spawn the first virtual object in the virtual environment by processing the first processing command, wherein the spawning is based on a determination that the first distance meets the first distance threshold

A computer device is further provided herein, comprising a processor and a memory. The memory has at least one program stored therein. The at least one program is loaded and executed by the processor to enable the computer device to implement the virtual object spawning method as described herein.

A non-transitory computer-readable storage medium is provided. The non-transitory computer-readable storage medium has at least one program stored therein. The at least one program is loaded and executed by a processor to enable a computer to implement the virtual object spawning method as described herein.

A computer program product or a computer program is provided. The computer program product or the computer program includes computer instructions, and the computer instructions are stored in a computer-readable storage medium. A processor of a computer device reads the computer instructions from the computer-readable storage medium, and the processor executes the computer instructions to enable the computer device to perform the virtual object spawning method provided herein.

### BRIEF DESCRIPTION OF THE DRAWINGS

FIG. 1 is a structural block diagram of a computer system according to one or more aspects described herein.

FIG. 2 is a schematic diagram of a process of spawning or destroying a virtual object according to one or more aspects described herein.

FIG. 3 is a schematic flowchart of a virtual object spawning method according to one or more aspects described herein.

FIG. 4 is a schematic flowchart of a virtual object spawning method according to one or more aspects described herein.

FIG. 5 is a schematic diagram of a system configuration interface according to one or more aspects described herein.

FIG. 6 is a schematic diagram of a debug interface according to one or more aspects described herein.

FIG. 7 is a schematic diagram of a system configuration interface according to one or more aspects described herein.

FIG. 8 is a schematic diagram of an initialization stage of a refresh and destroy system according to one or more aspects described herein.

FIG. 9 is a schematic diagram of a refresh command processing procedure stage according to one or more aspects described herein.

FIG. 10 is a schematic structural diagram of a virtual object spawning apparatus according to one or more aspects described herein.

FIG. 11 is a schematic structural diagram of a virtual object spawning apparatus according to one or more aspects described herein.

FIG. 12 is a schematic structural diagram of a terminal according to one or more aspects described herein.

### DETAILED DESCRIPTION

To make the objectives, technical solutions, and advantages of this application clearer, the following further describes implementation details with reference to the accompanying drawings.

Terms used herein are described below.

Open big world game: also referred to as a free roam game, which is a game level design in which a player may freely roam in a virtual world (virtual environment) and may freely select a time point and a manner for completing a game task.

User interface (UI) control: any visual control or element that can be seen on a user interface of an application, for example, a picture, an input box, a text box, a button, or a label. Some UI controls may respond to user operations.

Virtual environment: a virtual environment that an application may display (or provide) when running on a terminal. The virtual environment may be a simulated environment of a real world, a semi-simulated semi-fictional environment, or a purely fictional environment. The virtual environment may be any one of a two-dimensional virtual environment, a 2.5-dimensional virtual environment, a three-dimensional virtual environment, or the like. This is not limited.

Virtual character: at least one movable object that may be controlled by a user in a virtual environment. The virtual character may be a virtual person, a virtual animal, an animated character, or the like. The virtual character may be a three-dimensional model created based on a skeleton animation technology. Each virtual character may have a shape and a volume in the virtual environment, and may occupy some space in the virtual environment. The virtual character may also be referred to as a virtual object.

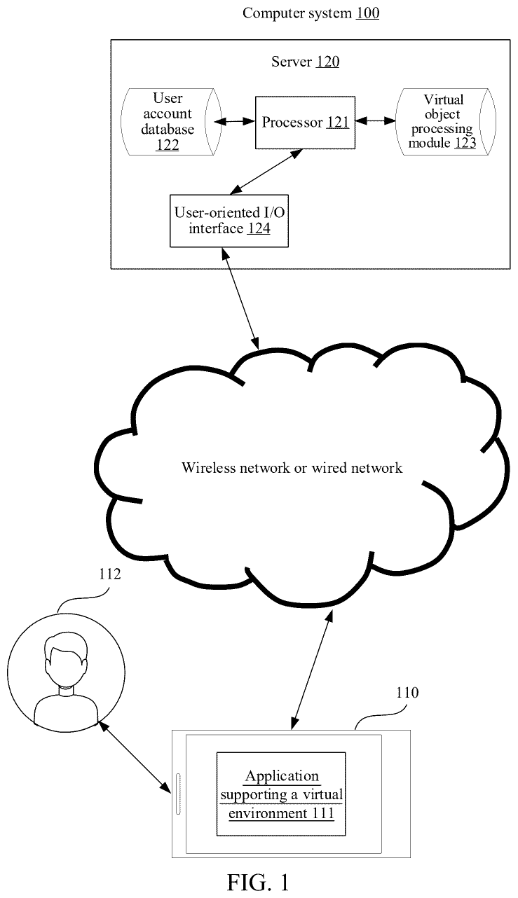

FIG. 1 is a structural block diagram of a computer system according to one or more aspects described herein. The computer system 100 includes a terminal 110 and a server 120.

The terminal 110 has an application 111 (client) supporting a virtual environment installed and running thereon. The application 111 may be specifically any one of an open big world game, a first-person shooting game (FPS), a third-personal shooting game (TPS), a multiplayer online battle arena game (MOBA), a battle arena game, a simulation game (SLG), a sandbox game, or the like. When the terminal 110 calls the application 111 to run, a user interface of the application 111 may be displayed on a screen of the terminal 110A virtual environment and a main control virtual object controlled by a user 112 may be displayed on the user interface. Based on movement of the main control virtual object in the virtual environment, another virtual object belonging to the virtual environment may be spawned or destroyed in the virtual environment. The terminal 110 may be a terminal used by the user 112, and a user account of the user 112 may be logged in to the application 111. The terminal 110 may be generally one of a plurality of terminals. A device type of the terminal 110 includes at least one of a smartphone, a tablet computer, an e-book reader, a Moving Picture Experts Group Audio Layer III (MP3) player, a Moving Picture Experts Group Audio Layer IV (MP4) player, a laptop portable computer, or a desktop computer.

The terminal 110 may be connected to the server 120 through a wireless network or a wired network.

The server 120 may include at least one of one server, a plurality of servers, a cloud computing platform, or a virtualization center. The server 120 may be configured to provide a background service for the application 111 supporting the virtual environment. the server 120 may be responsible for primary computing work, and the terminal 110 may be responsible for secondary computing work. Alternatively, the server 120 may be responsible for secondary computing work, and the terminal 110 may be responsible for primary computing work. Alternatively, a distributed computing architecture may be used between the server 120 and the terminal 110 for collaborative computing.

In an example, the server 120 includes a processor 121, a user account database 122, a virtual object processing module 123, and a user-oriented input/output interface (I/O interface) 124. The processor 121 may be configured to load instructions stored on the server 120 and process data in the user account database 122 and the virtual object processing module 123. The user account database 122 may be configured to store data of user accounts used by the terminal 110 and other terminals, such as avatars of the user accounts, nicknames of the user accounts, and groups to which the user accounts belong. The virtual object processing module 123 may be configured to control spawning and destroying of other virtual objects in the virtual environment based on movement of the main control virtual object in the virtual environment. The user-oriented I/O interface 124 may be configured to establish communication with the terminal 110 through a wireless network or a wired network for data exchange.

The application 111 may independently perform one or more operations described herein to control spawning and destroying of other virtual objects in the virtual environment based on movement of the main control virtual object in the virtual environment.

The server 120 may independently perform one or more operations described herein. When the server determines, based on movement of the main control virtual object in the virtual environment, to spawn or destroy another virtual object in the virtual environment, the server 120 may send an instruction to the application 111, to instruct the application 111 to spawn, according to the instruction, a virtual object to be spawned as determined by the server 120 and/or destroy a virtual object to be destroyed as determined by the server 120.

In the related art, by using a location of a main control virtual object as a center block of nine blocks, a game server queries whether a virtual object in another block in a virtual environment has been spawned in the virtual environment. If a virtual object located in another block in the virtual environment has not been spawned in the virtual environment, the game server controls a client to spawn the virtual object.

Because the main control virtual object can freely move in the virtual environment, the game server needs to frequently spawn virtual objects in the virtual environment. When virtual objects are spawned in the foregoing manner (i.e., in the related art), all virtual objects in an area covered by the nine blocks can be spawned only based on the area. Spawning of the virtual objects cannot be precisely controlled, and accuracy of displaying the virtual objects is reduced. In a scenario in which virtual objects need to be frequently spawned, display effect of the virtual objects is seriously degraded. Consequently, interaction experience of an interaction object is poor, and a human-computer interaction rate is reduced.

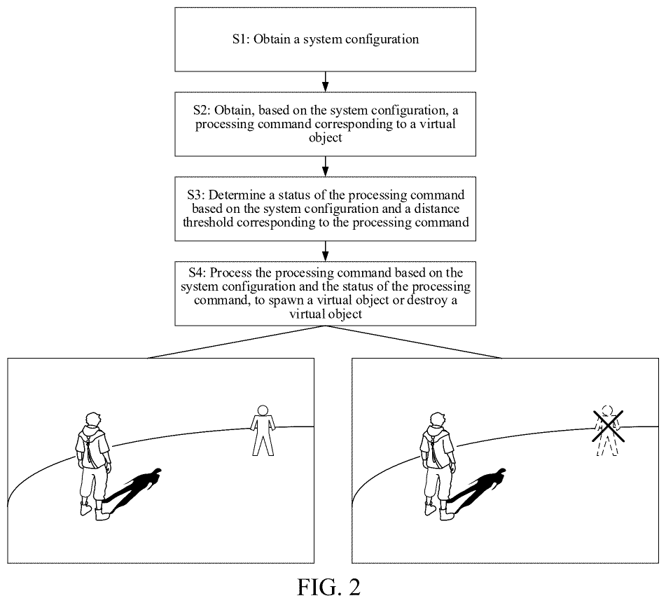

FIG. 2 is a schematic diagram of a process of spawning or destroying a virtual object.

In operation S1, a computer device may obtain a system configuration of a spawn and destroy system. The system configuration may be configured for configuring a process of spawning or destroying a virtual object in a virtual environment other than a main control virtual object controlled by a user, and configuring, for different types of virtual objects, a first distance threshold for triggering spawning of a virtual object and a second distance threshold for triggering destroying of a virtual object.

In operation S2, the computer device obtains, based on frequency and a quantity indicated by the system configuration, a first processing command corresponding to a first virtual object and/or a second processing command corresponding to a second virtual object. The first virtual object may be a virtual object that has not been spawned in the virtual environment. The second virtual object may be a virtual object already spawned in the virtual environment. The first processing command may correspond to a first distance threshold and a spawn location. The second processing command may correspond to a second distance threshold. The spawn location may be a location configured for spawning the first virtual object in the virtual environment.

In operation S3, the computer device may determine, based on the frequency indicated by the system configuration, a relationship between the first distance threshold corresponding to the first processing command and a first distance, to determine a processing status of the first processing command, the first distance being a distance between the main control virtual object and the spawn location. The computer device may determine, based on the frequency indicated by the system configuration, a relationship between the second distance threshold corresponding to the second processing command and a second distance, to determine a processing status of the second processing command, the second distance being a distance between the main control virtual object and the second virtual object. Based on a determination that the first distance is less than the first distance threshold, the computer device may determine that the first processing command is in a spawn waiting state; and when the second distance is greater than the second distance threshold, the computer device may determine that the second processing command is in a destroy waiting state.

In operation S4, the computer device may process the first processing command and/or the second processing command based on the frequency indicated by the system configuration, to spawn the first virtual object and/or destroy the second virtual object. Spawning the first virtual object may comprise loading a display resource corresponding to the first virtual object, to display the first virtual object in the virtual environment; and destroying the second virtual object may comprise canceling loading of a display resource corresponding to the second virtual object, to cancel displaying of the second virtual object in the virtual environment. The first processing command further may correspond to a second distance threshold, and after the first virtual object is spawned, the first virtual object may be considered as having been converted into a second virtual object, and the first processing command may be considered as having been converted into a second processing command; and the second processing command further may correspond to a first distance threshold and a spawn location, and after the second virtual object is destroyed, the second virtual object may be considered as having been converted into a first virtual object, and the second processing command may be considered as having been converted into a first processing command. In the foregoing solution, a virtual object may be cyclically spawned and destroyed based on a processing command of the virtual object.

For example, as shown in a diagram on the left below operation S4 in FIG. 2, the computer device spawns the first virtual object in the virtual environment based on a distance between the main control virtual object (on the left) and the spawn location of the first virtual object that has not been spawned (on the right). As shown in a diagram on the right below operation S4 in FIG. 2, the computer device destroys the second virtual object in the virtual environment based on a distance between the main control virtual object (on the left) and the second virtual object that has already been spawned (on the right).

The first virtual object that has not been spawned may be spawned based on a distance between the main control virtual object and the spawn location of the first virtual object in the virtual environment. The second virtual object that has been spawned may be destroyed based on a distance between the main control virtual object and the second virtual object in the virtual environment. In this way, spawning (display) and destroying (hiding) of each virtual object around the main control virtual object can be separately and precisely controlled, to improve accuracy of displaying and hiding the virtual object. In addition, a spawning or destroying process of a virtual object may be abstracted into a processing procedure of a processing command, so that an entity for performing the foregoing method can be freely selected. In this way, the following problem can be avoided: A server cannot frequently calculate a condition for spawning or destroying a virtual object due to excessively high computing load, and consequently, a client cannot spawn or destroy the virtual object in a timely manner.

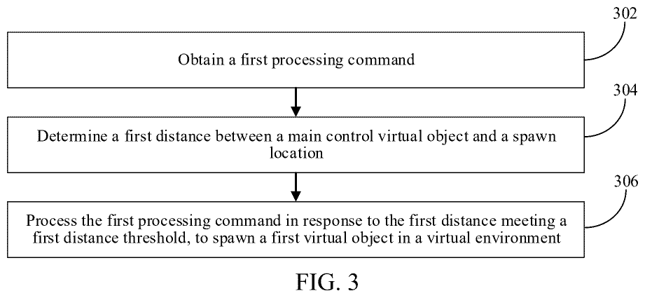

FIG. 3 is a schematic flowchart of a virtual object spawning method according to one or more aspects described herein. The method may be applied to a computer device or a client on a computer device. The computer device may be a terminal or a server. For example, the method may be applied to a server, or may be applied to a client that supports a virtual environment on a terminal. As shown in FIG. 3, the method includes the following operations.

Operation 302: Obtain a first processing command.

For example, the obtaining a first processing command may comprise obtaining a first processing command corresponding to a first virtual object that has not been spawned in a virtual environment.

The virtual environment may be a simulated environment of a real world, a semi-simulated semi-fictional environment, or a purely fictional environment. The virtual environment may be a virtual environment in a big world map. The big world map can provide a plurality of virtual environments. For example, each area in the big world map may be one virtual environment The virtual environment may be developed by using Unreal Engine 4 (UE4), or the virtual environment can be developed by using another game engine.

The first virtual object may belong to the virtual environment, and the first virtual object may comprise any virtual object that has not been spawned in the virtual environment. The first virtual object may comprise a simulated object for an object in the real world, or a semi-simulated semi-fictional object, or a purely fictional object. Specifically, the virtual object may comprise a virtual person, a virtual animal, an animated character, an interaction object, or the like. That the first virtual object has not been spawned in the virtual environment may be indicated by the first virtual object may not having been spawned after the virtual environment is displayed; or by first virtual object being spawned after the virtual environment is displayed, but currently being destroyed. If the first virtual object has not been spawned in the virtual environment, the first virtual object may not be displayed in the virtual environment. For example, the first virtual object is a virtual object different from a main control virtual object. For example, the first virtual object is an NPC that has not been spawned in the virtual environment and that is not controlled by any user.

Each virtual object in the virtual environment may correspond to a processing command, and the first processing command may control a spawning process of the first virtual object. The first processing command corresponding to the first virtual object may include at least one of an identifier of the first virtual object, a spawn location of the first virtual object, rotation information of the first virtual object, or other information configured for spawning the first virtual object. In The first processing command may be determined by the computer device based on information outputted by a spawner, and the spawner may be configured to output information needed for spawning a virtual object in the virtual environment.

The first processing command may correspond to a first distance threshold and a spawn location. The first distance threshold may indicate a triggering condition for spawning of the first virtual object. To be specific, the first distance threshold may be used to determine whether to spawn the first virtual object. The spawn location may indicate a location for spawning the first virtual object in the virtual environment. To be specific, when the first virtual object is spawned in the virtual environment, the first virtual object may be spawned at the spawn location in the virtual environment.

In the big world map, a virtual environment may be switched, and in this case, a virtual object belonging to the virtual environment may also be switched.

The computer device may obtain one or more first processing commands. The computer device may obtain, based on frequency and a quantity indicated by a configuration or determined by the computer device, a processing command corresponding to a virtual object that has not been spawned in the virtual environment, to obtain the first processing command.

Operation 304: Determine a first distance between the main control virtual object and the spawn location.

The main control virtual object may be a virtual object controlled by a user account in the virtual environment, and the user account can control the main control virtual object to freely move in the virtual The main control virtual object may comprise a simulated object for an object in the real world, or a semi-simulated semi-fictional object, or a purely fictional object. The main control virtual object may be a virtual character, and control that can be performed by the user account on the virtual character may include but is not limited to at least one of body posture adjustment, crawling, walking, running, riding, flying, jumping, driving, picking, shooting, attacking, throwing, skill casting, dashing, or guarding.

The first distance may be a linear distance between the main control virtual object and the first spawn location in the virtual environment, or the first distance may be a shortest moving distance between the main control virtual object and the first spawn location that is determined based on a movable route in the virtual environment. A specific manner of calculating the first distance is not limited. The computer device may determine the first distance when determining whether to spawn the first virtual object by using the first distance threshold, or periodically may determine the first distance.

Operation 306: Process the first processing command in response to the first distance meeting the first distance threshold, to spawn the first virtual object in the virtual environment.

That the first distance meets the first distance threshold may indicate that the first distance is less than or equal to the first distance threshold. The spawned first virtual object can move according to a preset rule, move under the control of a program, or freely move in the virtual environment, or the first virtual object may be stationary in the virtual environment.

The computer device may obtain one or more first processing commands. The computer device may determine, based on frequency and a quantity indicated by a configuration or determined by the computer device, a magnitude relationship between the first distance threshold corresponding to the first processing command and the first distance, to determine whether to process the first processing command. The computer device may process the first processing command based on the frequency and the quantity indicated by the configuration or determined by the computer device, to spawn the first virtual object.

For example, when the computer device obtains a plurality of first processing commands, each first processing command corresponds to a first distance threshold and a spawn location. For example, different first processing commands correspond to different spawn locations, to ensure that different first virtual objects are spawned at different locations. For example, first distance thresholds corresponding to different first processing commands may be the same or different.

For a virtual object (second virtual object) already spawned in the virtual environment, the computer device can control destroying of the second virtual object according to a second processing command corresponding to the second virtual object. The second processing command may correspond to a second distance threshold configured for triggering destroying of the second virtual object.

The second virtual object may be the same as or different from the first virtual object. When the second virtual object and the first virtual object are the same virtual object in different states, after being spawned in the virtual environment, the first virtual object may be considered as having been converted into a second virtual object, and the first processing command corresponding to the first virtual object may be considered as having been converted into a second processing command corresponding to the second virtual object. In this case, the first processing command may also correspond to a second distance threshold. The first distance threshold corresponding to the first processing command is different from the second distance threshold corresponding to the first processing command. For example, the first distance threshold is less than the second distance threshold. Processes of spawning and destroying a virtual object can be more precisely controlled by using different distance thresholds.

The method may be applied to a client supporting the virtual environment. In this case, the client may independently perform the operations to control spawning and destroying of other virtual objects in the virtual environment based on movement of the main control virtual object in the virtual environment. A server can provide a function of checking a virtual object to be spawned as determined by the client and/or a virtual object to be destroyed as determined by the client, to check whether the client correctly determines to spawn the virtual object and/or determines to destroy the virtual object.

The method may be applied to a server. In this case, the server may independently perform the operations. When the server determines, based on movement of the main control virtual object in the virtual environment, to spawn or destroy another virtual object in the virtual environment, the server may send an instruction to a client, to instruct the client to spawn, according to the instruction, a virtual object to be spawned as determined by the server and/or destroy a virtual object to be destroyed as determined by the server. When executing the instruction, the client may use a framing execution policy. The server may include a client/server (CS) server in a CS architecture, or a dedicated server (DS). The dedicated server may support a function of storing a virtual environment (for example, big world) map.

The first virtual object that has not been spawned (i.e., un-spawned) may be spawned based on a distance between the main control virtual object and the spawn location of the first virtual object in the virtual environment. In this way, spawning of each virtual object around the main control virtual object can be separately and precisely controlled, to improve accuracy of displaying the virtual object. Even in a scenario in which virtual objects need to be frequently spawned, display effect of the virtual objects can be ensured, to improve interaction experience of an interaction object and further increase a human-computer interaction rate.

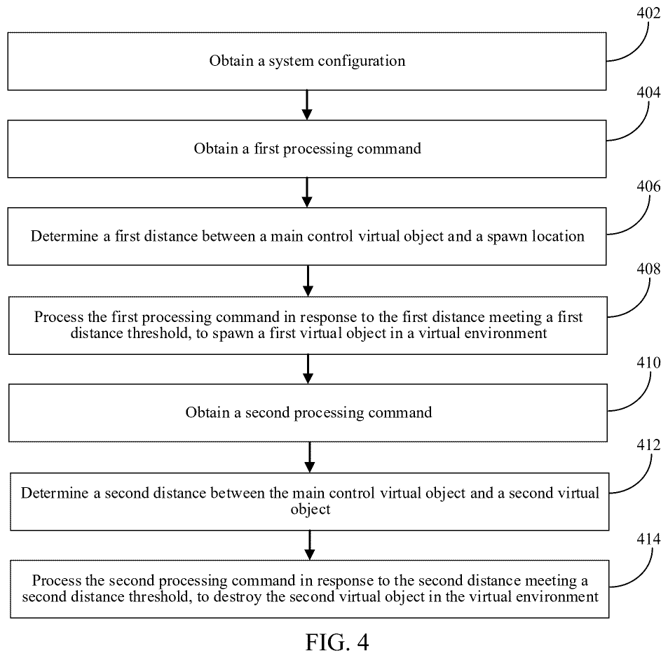

FIG. 4 is a schematic flowchart of a virtual object spawning method according to one or more aspects described herein. The method may be applied to a computer device or a client on a computer device. The computer device may be a terminal or a server. For example, the method may be applied to a server, or may be applied to a client that supports a virtual environment on a terminal. As shown in FIG. 4, the method includes the following operations.

Operation 402: Obtain a system configuration.

The system configuration is configured for configuring a spawning process of a virtual object that has not been spawned in a virtual environment, and/or a destroying process of a virtual object that is already spawned in the virtual environment. The system configuration is a configuration of a virtual object spawn and destroy system. The virtual object spawn and destroy system is configured to control spawning and/or destroying of a virtual object in the virtual environment by using the method provided herein during running of a client that supports the virtual environment. The virtual object spawn and destroy system may be integrated in the client. The virtual object spawn and destroy system may be integrated in the server.

The system configuration includes at least one of the following information:
distance thresholds configured for triggering spawning of different types of virtual objects;
distance thresholds configured for triggering destroying of different types of virtual objects;
a first quantity of interval frames;
a second quantity of interval frames;
a processing quantity;
a time interval; or
a debug configuration.

The computer device can display a system configuration interface, and the system configuration interface is configured for configuring the system configuration.

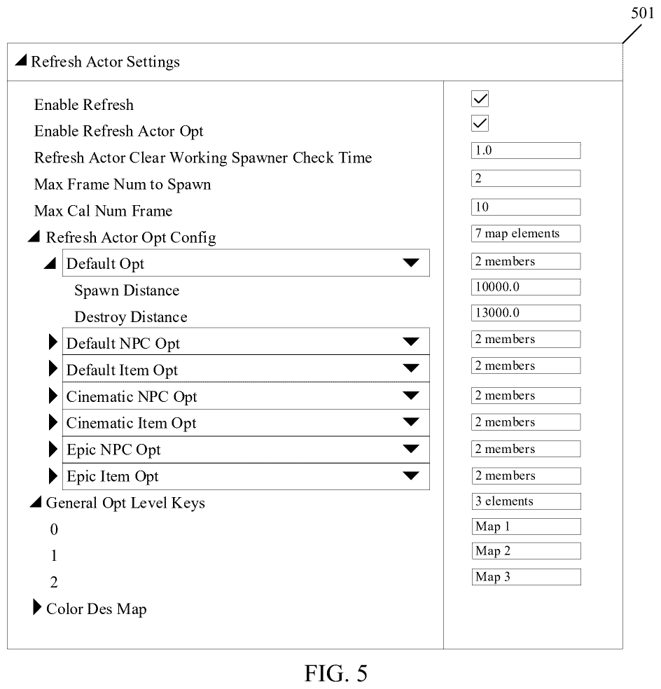

FIG. 5 is a schematic diagram of a system configuration interface according to one or more aspects described herein. As shown in FIG. 5, a title “Refresh Actor Settings” may be displayed on the system configuration interface 501. A plurality of to-be-configured items may be displayed below the title (for example, Enable Refresh, Enable Refresh Actor Opt, and Refresh Actor Clear Working Spawner Check Time). Different to-be-configured items may be configured for configuring information in different aspects. The to-be-configured items are described below. “Enable Refresh” may be configured for configuring whether to enable a virtual object refresh and destroy system. The “refreshing” may refer to the spawning or the triggering of the spawning. The virtual object refresh and destroy system may also be referred to as a virtual object spawn and destroy system. “Enable Refresh Actor Opt” may be configured for configuring whether to enable a function of configuring corresponding distance thresholds for triggering spawning and corresponding distance thresholds for triggering destroying for different types of virtual objects. “Refresh Actor Clear Working Spawner Check Time” (or Clear Working Spawner Time) may be configured for configuring the time interval. “Max Frame Num to Spawn” may be configured for configuring the first quantity of interval frames. “Max Cal Num Frame” may be configured for configuring the second quantity of interval frames. One or more options under “Refresh Actor Opt Configuration” are configured for configuring distance thresholds for triggering spawning and distance thresholds for triggering destroying that correspond to different types of virtual objects. “General Opt Level Keys” is configured for configuring maps (virtual environments) in which the virtual object spawn and destroy system is used or not used to control spawning and destroying of virtual objects when the virtual object spawn and destroy system is enabled. “Color Des Map” may be configured for configuring the debug configuration. The system configuration interface 501 is merely used as an example, but does not show all information included in the system configuration, and is not construed as a limitation on the system configuration.

The foregoing descriptions of the information in the system configuration are used as overall descriptions of the system configuration, and the foregoing information is applied to different stages of a process of controlling spawning or destroying of a virtual object. Addition details of the information in the system configuration are discussed below but are not limiting.

Operation 404: Obtain a first processing command.

Obtaining a first processing command may comprise obtaining a first processing command corresponding to a first virtual object that has not been spawned in a virtual environment. The first processing command may be configured for controlling a spawning process of the first virtual object. The first processing command may correspond to a first distance threshold configured for triggering spawning of the first virtual object and a spawn location. The first distance threshold may be configured for determining whether to spawn the first virtual object. The spawn location may be a location configured for spawning the first virtual object in the virtual environment. To be specific, when the first virtual object is spawned in the virtual environment, the first virtual object may be spawned at the spawn location in the virtual environment.

The system configuration obtained by the computer device may include first distance thresholds respectively corresponding to a plurality of types of virtual objects. For example, still as shown in FIG. 5, virtual objects may be classified into the following types: “Default Opt”, “Default NPC Opt”, “Default Item Opt”, “Cinematic NPC Opt”, “Cinematic Item Opt”, “Epic NPC Opt”, and “Epic Item Opt”. A type of a virtual object further may include “Ignore Opt”. A relationship between a virtual object and a type of the virtual object may be set by a developer, and a virtual object of the Ignore Opt type may be a virtual object participating in checking whether a spawn location is on the ground. Each type of virtual object may correspond to a first distance threshold, namely, Spawn Distance, that may be set for the type of virtual object.

The computer device may obtain a command data set (Cache Command Spawners Map), determine a to-be-calculated processing command from the command data set, and add the to-be-calculated processing command to a to-be-calculated array (Cache Command Spawners), to obtain the first processing command from the to-be-calculated array. The command data set may be configured for storing a processing command corresponding to a virtual object that has not been spawned in the virtual environment.

The computer device may determine the to-be-calculated processing command according to an order of processing commands in the command data set, or may randomly determine the to-be-calculated processing command, or may determine the to-be-calculated processing command based on importance of a virtual object corresponding to a processing command. For example, the computer device may use processing commands ranked in a first quantity of positions from the front in the command data set as to-be-calculated processing commands; or the computer device may randomly select a first quantity of processing commands from the command data set as to-be-calculated processing commands; or the computer device may use, as a to-be-calculated processing command, a processing command that is in the command data set and that corresponds to a virtual object whose importance is greater than a first importance threshold; or the computer device may use, as to-be-calculated processing commands, processing commands that are in the command data set and that correspond to virtual objects whose importance is ranked in the first quantity of positions from the front. The first quantity may be a quantity of to-be-calculated processing commands that need to be determined from the command data set. The first quantity and the first importance threshold may be set based on experience, or may be flexibly adjusted according to a requirement.

The computer device may obtain the first processing command according to an order of processing commands in the to-be-calculated array, or may randomly obtain the first processing command, or may obtain the first processing command based on importance of a virtual object corresponding to a processing command. The importance may be set by a developer, or may be determined based on whether the virtual object is related to a current task of the main control virtual object (importance of a virtual object related to the current task of the main control virtual object may be higher than importance of a virtual object unrelated to the current task of the main control virtual object), or may be determined based on a profit of the main control virtual object defeating the virtual object, or may be determined based on whether the main control virtual object can interact with the virtual object (importance of a virtual object that can interact with the main control virtual object may be higher than importance of a virtual object that cannot interact with the main control virtual object).

For example, the computer device may use processing commands ranked in a second quantity of positions from the front in the to-be-calculated array as first processing commands; or the computer device may randomly select a second quantity of processing commands from the to-be-calculated array as first processing commands; or the computer device may use, as a first processing command, a processing command that is in the to-be-calculated array and that corresponds to a virtual object whose importance is greater than a second importance threshold; or the computer device may use, as first processing commands, processing commands that are in the to-be-calculated array and that correspond to virtual objects whose importance is ranked in the second quantity of positions from the front. The second quantity may be a quantity of first processing commands that need to be determined from the to-be-calculated array. The second quantity and the second importance threshold may be set based on experience, or may be flexibly adjusted according to a requirement.

The computer device may trigger determining of the to-be-calculated processing command from the command data set in response to an interval between a current quantity of frames and a second quantity of frames being greater than the second quantity of interval frames. The second quantity of frames may be a quantity of frames when a to-be-calculated processing command is determined from the command data set at a previous time. The second quantity of interval frames may be indicated by the system configuration, or may be determined by the computer device, or may be obtained by the computer device by updating a configured second quantity of interval frames when the second quantity of interval frames is indicated by the system configuration.

The computer device determine and/or update the second quantity of interval frames in at least one of the following manners:
determining the second quantity of interval frames based on a quantity of processing commands in the command data set;
determining the second quantity of interval frames based on a moving speed of the main control virtual object; or
determining the second quantity of interval frames based on a quantity of virtual objects that have been spawned in the virtual environment.

The second quantity of interval frames may be determined based on at least one of the quantity of processing commands in the command data set, the moving speed of the main control virtual object, or the quantity of virtual objects that have been spawned in the virtual environment.

For example, the second quantity of interval frames may be negatively correlated with the quantity of processing commands in the command data set. To be specific, a larger quantity of processing commands in the command data set may indicate a smaller second quantity of interval frames. In this way, when the command data set includes a large quantity of processing commands, frequency of determining a to-be-calculated processing command from the command data set may be increased, to avoid a case that a processing command in the command data set cannot be processed in a timely manner. The frequency of determining a to-be-calculated processing command from the command data set may be negatively correlated with the second quantity of interval frames. To be specific, a smaller second quantity of interval frames may indicate higher frequency of determining a to-be-calculated processing command from the command data set.

For example, the second quantity of interval frames may be positively correlated with the moving speed of the main control virtual object. To be specific, a higher moving speed of the main control virtual object may indicate a larger second quantity of interval frames. In this way, when the moving speed of the main control virtual object is high, frequency of determining a to-be-calculated processing command from the command data set may be reduced, to reduce frequency of spawning a virtual object by processing a to-be-calculated processing command, and avoid a case that a distance between the main control virtual object and a spawn location of a virtual object exceeds the first distance threshold when the virtual object newly appears through refreshing, so that a waste of computing resources is reduced.

For example, the second quantity of interval frames may be positively correlated with the quantity of virtual objects that have been spawned in the virtual environment. To be specific, a larger quantity of virtual objects that have been spawned in the virtual environment may indicate a larger second quantity of interval frames. In this way, when a large quantity of virtual objects has been spawned in the virtual environment, frequency of determining a to-be-calculated processing command from the command data set can be reduced, to reduce frequency of spawning a virtual object by processing a to-be-calculated processing command, and avoid a case that visual effect for an interaction object is degraded due to displaying of excessive virtual objects. Therefore, interaction experience of the interaction object is improved, and a human-computer interaction rate is further increased.

The computer device can update the second quantity of interval frames according to a manner of updating the first quantity of interval frames. For example, if the first quantity of interval frames is increased, the second quantity of interval frames may be increased; or if the first quantity of interval frames is decreased, the second quantity of interval frames may be decreased. In terms of updating the second quantity of interval frames, the computer device can re-determine a second quantity of interval frames; or the system configuration may include a plurality of candidate second quantities of interval frames, and the computer device may determine a current second quantity of interval frames from the plurality of candidate second quantities of interval frames in the foregoing manner.

When determining a to-be-calculated processing command, the computer device may determine to-be-calculated processing commands whose quantity is not greater than a processing quantity from the command data set.

For example, the processing quantity may be indicated by the system configuration, or may be determined by the computer device, or may be obtained by the computer device by updating a configured processing quantity when the processing quantity is indicated by the system configuration. The computer device can also update the processing quantity according to a manner of updating the first quantity of interval frames and updating the second quantity of interval frames. For example, if the first quantity of interval frames and the second quantity of interval frames are increased, the processing quantity may be increased; or if the first quantity of interval frames and the second quantity of interval frames are decreased, the processing quantity may be decreased. In terms of updating the processing quantity, the computer device can re-determine a processing quantity; or the system configuration may include a plurality of candidate processing quantities, and the computer device may determine a current processing quantity from the plurality of candidate processing quantities in the foregoing manner.

In response to a current moment meeting a period indicated by a time interval, the computer device may determine, in a multithreaded manner, whether to process the to-be-calculated processing command in the to-be-calculated array. A process of determining whether to process the to-be-calculated processing command may be implemented by determining whether a condition for spawning a virtual object corresponding to the to-be-calculated processing command is met. When the condition for spawning the virtual object corresponding to the to-be-calculated processing command is met, the to-be-calculated processing command may be processed. When the condition for spawning the virtual object corresponding to the to-be-calculated processing command is not met, the to-be-calculated processing command may not be processed. The condition for spawning the virtual object corresponding to the to-be-calculated processing command may be that a first distance between the main control virtual object and a spawn location of the virtual object corresponding to the to-be-calculated processing command meets a first distance threshold corresponding to the to-be-calculated processing command.

For example, during the determining, in a multithreaded manner, whether to process the to-be-calculated processing command in the to-be-calculated array, determining may be concurrently performed for a plurality of to-be-calculated processing commands in the to-be-calculated array, to improve determining efficiency and further improve virtual object spawning efficiency.

For example, the time interval may be indicated by the system configuration, or may be determined by the computer device, or may be obtained by the computer device by updating a configured time interval when the time interval is indicated by the system configuration. The computer device can also update the time interval according to a manner of updating the first quantity of interval frames and updating the second quantity of interval frames. For example, if the first quantity of interval frames and the second quantity of interval frames are increased, the time interval may be increased; or if the first quantity of interval frames and the second quantity of interval frames are decreased, the time interval may be decreased. In terms of updating the time interval, the computer device can re-determine a time interval; or the system configuration may include a plurality of candidate time intervals, and the computer device may determine a current time interval from the plurality of candidate time intervals in the foregoing manner.

Operation 406: Determine a first distance between the main control virtual object and the spawn location.

The main control virtual object may be a virtual object controlled by a user account in the virtual environment, and the user account can control the main control virtual object to freely move in the virtual environment. The first distance may be a linear distance between the main control virtual object and the spawn location in the virtual environment, or the first distance may be a shortest moving distance between the main control virtual object and the spawn location that may be determined based on a movable route in the virtual environment. A specific manner of calculating the first distance is not limited.

Operation 408: Process the first processing command in response to the first distance meeting the first distance threshold, to spawn the first virtual object in the virtual environment.

That the first distance meets the first distance threshold includes that the first distance is less than the first distance threshold. In response to the first distance being less than the first distance threshold, the computer device may determine that the first processing command is in a spawn waiting state, and then may process the first processing command in the spawn waiting state to spawn the first virtual object in the virtual environment.

In response to the first distance being less than the first distance threshold, the computer device may add the first processing command in the to-be-calculated array to a to-be-spawned array, set the first processing command in the to-be-spawned array to a spawn waiting state, and add the first processing command to an array being spawned. Then the computer device may process the first processing command in the spawn waiting state in the array being spawned.

In response to an interval between the current quantity of frames and a first quantity of frames being greater than the first quantity of interval frames, the computer device may process the first processing command in the spawn waiting state in the array being spawned, to spawn the first virtual object in the virtual environment. The first quantity of frames may be a quantity of frames when a virtual object is spawned in the virtual environment at a previous time. The first quantity of interval frames may be indicated by the system configuration, or may be determined by the computer device, or may be obtained by the computer device by updating a configured first quantity of interval frames when the first quantity of interval frames is indicated by the system configuration.

The computer device determine and/or update the first quantity of interval frames in at least one of the following manners:
determining the first quantity of interval frames based on a moving speed of the main control virtual object;
determining the first quantity of interval frames based on a distance between a
current location and a historical location of the main control virtual object;
determining the first quantity of interval frames based on a behavior type of the main control virtual object;
determining the first quantity of interval frames based on a virtual vehicle taken by the main control virtual object;
determining the first quantity of interval frames based on environment information of the virtual environment;
determining the first quantity of interval frames based on a behavior type of a virtual object that has been spawned in the virtual environment;
determining the first quantity of interval frames based on a quantity of virtual objects that have been spawned in the virtual environment; or
determining the first quantity of interval frames according to an estimated computing resource corresponding to a processing command in the spawn waiting state in the array being spawned.

In other words, the first quantity of interval frames may be determined based on at least one of the moving speed of the main control virtual object, the distance between the current location and the historical location of the main control virtual object, the behavior type of the main control virtual object, the virtual vehicle taken by the main control virtual object, the environment information of the virtual environment, the behavior type of the virtual object that has been spawned in the virtual environment, the quantity of virtual objects that have been spawned in the virtual environment, or the estimated computing resource corresponding to the processing command in the spawn waiting state in the array being spawned.

The moving speed of the main control virtual object may be positively correlated with the first quantity of interval frames. The system configuration may include a plurality of candidate first quantities of interval frames. Each candidate first quantity of interval frames may correspond to a speed range. The computer device may determine, based on a current moving speed of the main control virtual object, a speed range corresponding to the current moving speed of the main control virtual object, and may determine the first quantity of interval frames based on a correspondence between the speed range and a candidate first quantity of interval frames. For example, a first speed range may be greater than a second speed range, and a candidate first quantity of interval frames corresponding to the first speed range may be greater than a candidate first quantity of interval frames corresponding to the second speed range. When the moving speed of the main control virtual object is high, a distance between the main control virtual object and a spawn location of a virtual object may also change fast. Therefore, when the moving speed of the main control virtual object is high, frequency of spawning a virtual object may be reduced to avoid a case that a distance between the main control virtual object and a spawn location of a virtual object exceeds the first distance threshold when the virtual object newly appears through refreshing, so that a waste of computing resources is reduced. The frequency of spawning a virtual object may be negatively correlated with the first quantity of interval frames. To be specific, a larger first quantity of interval frames may indicate lower frequency of spawning a virtual object. The frequency of spawning a virtual object may also be referred to as spawning frequency of a virtual object.

The historical location may be a location of the main control virtual object when a virtual object is spawned in the virtual environment at a previous time. The distance between the current location and the historical location of the main control virtual object may be negatively correlated with the first quantity of interval frames. To be specific, a larger distance between the current location and the historical location of the main control virtual object may indicate a smaller first quantity of interval frames. In this way, when the main control virtual object has moved by a long distance, a virtual object can be faster spawned to interact with the main control virtual object, to improve interaction experience of an interaction object and further increase a human-computer interaction rate.

The behavior type of the main control virtual object may be a type of a current behavior of the main control virtual object. The behavior type may include at least one of a battle behavior, a task execution behavior, or a free activity behavior. The battle behavior may be a behavior of the main control virtual object battling with another virtual object in the virtual environment. The task execution behavior may be a behavior of the main control virtual object performing a task without participating in a battle currently. The free activity behavior may be a behavior other than the battle behavior and the task execution behavior. The system configuration may include a first candidate first quantity of interval frames, a second candidate first quantity of interval frames, and a third candidate first quantity of interval frames. The first candidate first quantity of interval frames may correspond to the battle behavior. The second candidate first quantity of interval frames may correspond to the task execution behavior. The third candidate first quantity of interval frames may correspond to the free activity behavior. The first candidate first quantity of interval frames may be greater than the second candidate first quantity of interval frames. The second candidate first quantity of interval frames may be greater than the third candidate first quantity of interval frames. For example, if the main control virtual object switches from the free activity behavior to participating in a battle in the virtual environment, a main focus may not be on a nearby virtual object. In this case, the third candidate first quantity of interval frames may be increased to the first candidate first quantity of interval frames. If the main control virtual object subsequently switches the battle behavior to the task execution behavior, a main focus may be on a nearby virtual object. In this case, the first candidate first quantity of interval frames may be decreased to the second candidate first quantity of interval frames. Different behaviors of the main control virtual object may affect a degree of attention paid by a user to a virtual object around the main control virtual object. The first quantity of interval frames may be controlled based on the behavior type of the main control virtual object. In this way, spawning frequency of a surrounding virtual object can be reduced when the degree of attention paid by the user to a virtual object around the main control virtual object decreases, and spawning frequency of a surrounding virtual object can be increased when the degree of attention paid by the user to a virtual object around the main control virtual object increases. In this solution, consumption of computing resources is reduced while user experience is ensured.

The virtual vehicle is a vehicle that can be driven by the main control virtual object in the virtual environment. The virtual vehicle includes a simulated vehicle for a vehicle in the real world, or a semi-simulated semi-fictional vehicle, or a purely fictional vehicle. Different virtual vehicles correspond to a same first quantity of interval frames or different first quantities of interval frames. The system configuration may include a plurality of candidate first quantities of interval frames. A candidate first quantity of interval frames corresponding to a flying vehicle may be greater than a candidate first quantity of interval frames corresponding to a terrestrial vehicle. The candidate first quantity of interval frames corresponding to the terrestrial vehicle may be greater than a candidate first quantity of interval frames corresponding to a water-surface vehicle. The candidate first quantity of interval frames corresponding to the water-surface vehicle may be greater than a candidate first quantity of interval frames corresponding to an underwater vehicle. For example, a candidate first quantity of interval frames corresponding to a virtual plane may be greater than a candidate first quantity of interval frames corresponding to a virtual car, and the candidate first quantity of interval frames corresponding to the virtual car may be greater than a candidate first quantity of interval frames corresponding to a virtual ship.

Different environment information may correspond to a same first quantity of interval frames or different first quantities of interval frames. For example, a first quantity of interval frames corresponding to the night may be less than a first quantity of interval frames corresponding to the late afternoon, the first quantity of interval frames corresponding to the late afternoon may be less than a first quantity of interval frames corresponding to the morning, and a first quantity of interval frames corresponding to a sunny day may be less than a first quantity of interval frames corresponding to a hazy day.

A behavior type of a virtual object that has been spawned may be a type of a current behavior of the virtual object. For example, when the virtual object is interacting with the main control virtual object, a first quantity of interval frames may be decreased; or when the virtual object is not interacting with the main control virtual object, a first quantity of interval frames may remain unchanged.

The first quantity of interval frames may be positively correlated with a quantity of virtual objects that have been spawned. To be specific, a larger quantity of virtual objects that have been spawned may indicate a larger first quantity of interval frames. In this way, when a large quantity of virtual objects have been spawned in the virtual environment, spawning frequency of a virtual object can be reduced, to avoid a case that visual effect for an interaction object is degraded due to displaying of excessive virtual objects, and improve interaction experience of the interaction object.

The estimated computing resource may be configured for estimating a computing resource to be consumed for spawning a virtual object corresponding to the processing command in the spawn waiting state. The estimated computing resource may be positively correlated with the first quantity of interval frames. To be specific, a larger amount of estimated computing resources may indicate a larger first quantity of interval frames. In this way, when a large amount of computing resources are consumed for spawning the virtual object corresponding to the processing command in the spawn waiting state, frequency of spawning a virtual object can be reduced, to reduce consumption of computing resources.

The computer device can update the first quantity of interval frames according to a manner of updating the second quantity of interval frames. For example, if the second quantity of interval frames is increased, the first quantity of interval frames may be increased; or if the second quantity of interval frames is decreased, the first quantity of interval frames may be decreased. In terms of updating the first quantity of interval frames, the computer device can re-determine a first quantity of interval frames; or the system configuration may include a plurality of candidate first quantities of interval frames, and the computer device may determine a current first quantity of interval frames from the plurality of candidate first quantities of interval frames in the foregoing manner. The computer device may periodically determine and/or update the first quantity of interval frames based on the system configuration, a behavior change of a virtual object, or based on an indication.

The computer device may set the first processing command to a spawning completed state in response to completion of processing of the first processing command in the spawn waiting state in the array being spawned. The first processing command in the spawning completed state in the array being spawned may configured for destroying the first virtual object in the virtual environment. To be specific, after the first virtual object is spawned, a processing command corresponding to the first virtual object may configured for controlling destroying of the first virtual object.

Operation 410: Obtain a second processing command.

For example, the obtaining a second processing command may comprise obtaining a second processing command corresponding to a second virtual object that has been spawned in the virtual environment. The second processing command may be configured for controlling a destroy process of the second virtual object. The second processing command may correspond to a second distance threshold configured for triggering destroying of the second virtual object. The second distance threshold may be configured for determining whether to destroy the second virtual object. For example, the second virtual object may be a virtual object different from a main control virtual object. For example, the second virtual object may be an NPC that has been spawned in the virtual environment and that is not controlled by any user.

The system configuration obtained by the computer device may include second distance thresholds respectively corresponding to a plurality of types of virtual objects. For example, still as shown in FIG. 5, each type of virtual object may include to a second distance threshold, namely, a destroy distance, that is set for the type of virtual object.

The computing device obtain the second processing command from processing commands in a spawning completed state in the array being spawned. The array being spawned may be configured for storing at least one of a processing command corresponding to a virtual object that has been spawned in the virtual environment and a processing command corresponding to a virtual object that is waiting to be destroyed. The processing command in the spawning completed state may be a processing command corresponding to the virtual object that has been spawned. The computer device may alternatively obtain the second processing command based on frequency and a quantity indicated by configuration information. Obtaining of the second processing command may be similar the manner of obtaining the first processing command, discussed above.

Operation 412: Determine a second distance between the main control virtual object and the second virtual object.

The second distance may be a linear distance between the main control virtual object and the second virtual object in the virtual environment, or the second distance may be a shortest moving distance between the main control virtual object and the second virtual object that is determined based on a movable route in the virtual environment. A specific manner of calculating the second distance is not limited.

Operation 414: Process the second processing command in response to the second distance meeting the second distance threshold, to destroy the second virtual object in the virtual environment.

That the second distance meets the second distance threshold includes that the second distance is greater than the second distance threshold. In response to the second distance being greater than the second distance threshold, the computer device determine that the second processing command is a destroy waiting state, and then may process the second processing command in the destroy waiting state (in the destroy waiting state in the array being spawned), to destroy the second virtual object in the virtual environment.

In response to completion of processing of the second processing command in the destroy waiting state in the array being spawned, the computer device may reset the second processing command (clears a state of the processing command) and add the second processing command to a command data set, to subsequently respawn the second virtual object. The command data set may be configured for storing a processing command corresponding to a virtual object that has not been spawned in the virtual environment.

The second virtual object may be the same as or different from the first virtual object. When the second virtual object and the first virtual object are the same virtual object in different states, after being spawned in the virtual environment, the first virtual object may be considered as having been converted into a second virtual object, and the first processing command corresponding to the first virtual object may be considered as having been converted into a second processing command corresponding to the second virtual object. In this case, the first processing command also may correspond to a second distance threshold. In addition, after being destroyed in the virtual environment, the second virtual object may be considered as having been converted into a first virtual object, and the second processing command corresponding to the second virtual object may be considered as having been converted into a first processing command corresponding to the first virtual object. In this case, the second processing command also may correspond to a first distance threshold. In addition, in this case, the second processing command further may correspond to a spawn location indicating a location configured for spawning the destroyed second virtual object in the virtual environment.

Operation 402 to operation 408 in the foregoing method may be separately performed and implemented as a virtual object spawning method. Operation 402, and operation 410 to operation 414 in the foregoing method may be separately performed and implemented as a virtual object destroy method.

When the system configuration includes the debug configuration, the computer device can further display a debug interface, the debug interface displaying at least the virtual environment and the main control virtual object. The computer device may display debug information on the debug interface based on the debug configuration. The debug information may be configured for indicating a processing status of the first processing command corresponding to the first virtual object. A display style of the debug information may vary in different processing statuses. The debug configuration may be configured for indicating display styles in different processing statuses. The processing status of the first processing command may be configured for indicating a current processing stage of the first processing command.

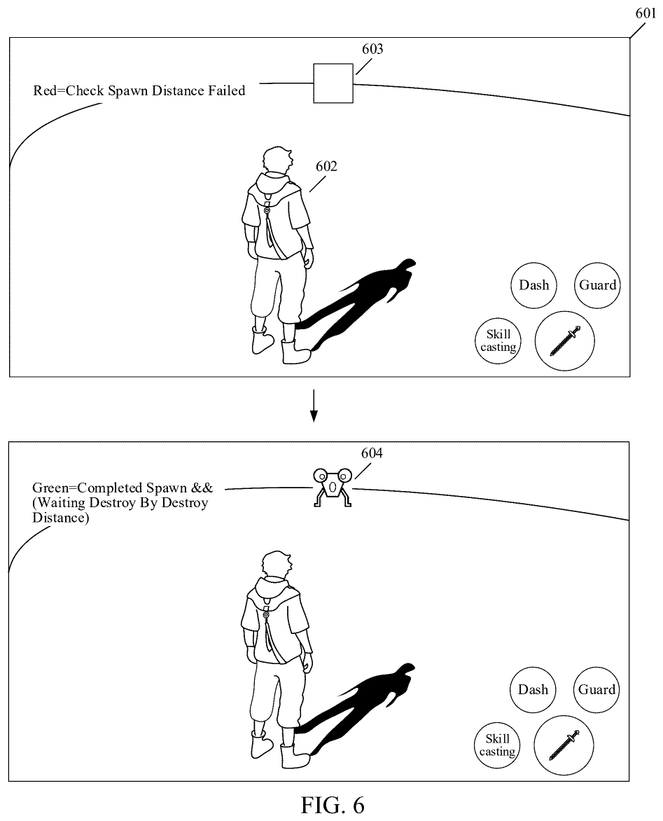

FIG. 6 is a schematic diagram of a debug interface according to one or more aspects described herein. As shown in FIG. 6, a virtual environment, a main control virtual object 602, and a spawn location 603 of a virtual object 604 may be displayed on the debug interface 601. Because a refresh condition (a distance threshold for triggering spawning of a virtual object) is not met, the computer device may check a refresh rule at specific frequency until the refresh condition is met. The refresh condition being not met may be indicated by a red debug prompt “Check Spawn Distance Failed”. After the virtual object 604 is refreshed, the computer device may determine, based on importance of the virtual object 604, whether a processing command corresponding to the virtual object 604 can clear (destroy) the virtual object 604. When the virtual object 604 is an unimportant object, the computer device may calculate, at specific frequency, whether a destroy condition (a distance threshold for triggering destroying of a virtual object) is met, and after the destroy condition is met, may destroy the virtual object 604 and update the processing command for the virtual object 604 to waiting for a next refresh. After the virtual object 604 is spawned, a green prompt “Completed Spawn && (Waiting Manually Destroy Or Level Stream Out)” may be displayed on the debug interface 601.

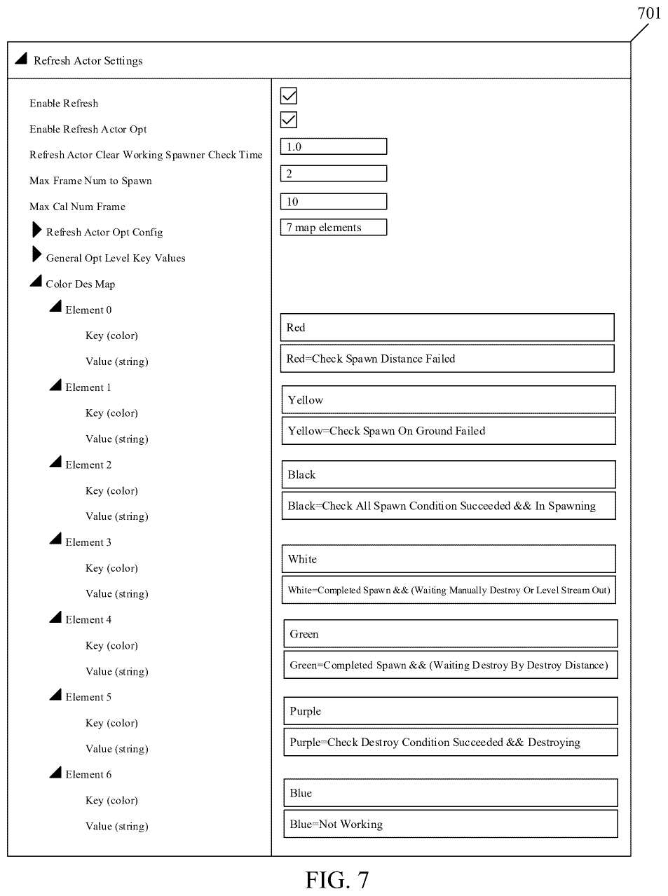

FIG. 7 is a schematic diagram of a system configuration interface according to one or more aspects described herein. As shown in FIG. 7, “Color Des Map” on the system configuration interface 701 may be configured for configuring the debug configuration. Content of different debug information and display trigger conditions (processing stages of the processing commands) corresponding to different debug information may be set in options corresponding to “Color Des Map”. For example, red debug information may indicate that check on a spawn distance fails (Red-Check Spawn Distance Failed), yellow debug information may indicate that check on spawning on the ground fails (Yellow-Check Spawn On Ground Failed) (a spawn location further needs to be on the ground in a virtual environment while a distance threshold for triggering spawning is met), black debug information may indicate that check on all spawning conditions has succeeded and the system is waiting for spawning (Black-Check All Spawn Condition Succeeded && In Spawning), white debug information may indicate that spawning is completed and the system is waiting for manual destroy or stream indication (White-Completed Spawn && (Waiting Manually Destroy Or Level Stream Out)), green debug information may indicate that spawning is completed and the system is waiting for destroy based on a destroy distance (Green=Completed Spawn && (Waiting Destroy By Destroy Distance)), purple debug information may indicate that check on a destroy condition has succeeded and destroying is in progress (Purple=Check Destroy Condition Succeeded && Destroying), and blue debug information may indicate that a virtual object spawn and destroy system is not running (Blue=Not Working).

The first virtual object that has not been spawned may be spawned based on a distance between the main control virtual object and the spawn location of the first virtual object in the virtual environment. In this way, spawning of each virtual object around the main control virtual object can be separately and precisely controlled, to improve accuracy of displaying the virtual object. Even in a scenario in which virtual objects need to be frequently spawned, display effect of the virtual objects can be ensured, to improve interaction experience of an interaction object and further increase a human-computer interaction rate.

A status of the first processing command may be further switched when the first distance is less than the first distance threshold, to provide a simple and convenient implementation of spawning a virtual object by using a processing command.

The first processing command may be further transferred between different arrays, so that a processing command can be accurately processed based on an array in different processing stages.

Frequency of spawning a virtual object may be further controlled, to avoid a problem that a large quantity of virtual objects are spawned within a short time, causing excessively high usage of computing resources.

The first quantity of interval frames may be further determined in a plurality of manners, so that the first quantity of interval frames can be flexibly determined based on an actual case.

A status of the first processing command may be further changed after the first virtual object is spawned, so that a virtual object that may need to be destroyed can be quickly determined.

A processing command for a virtual object may be further managed by maintaining the command data set, to provide a simple and convenient manner of maintaining a processing command for a virtual object.

A processing command waiting for calculation may be further obtained based on the second quantity of interval frames, to avoid a problem that a large amount of calculation is performed within a short time, causing excessively high usage of computing resources.

The second quantity of interval frames may be further determined in a plurality of manners, so that the second quantity of interval frames can be flexibly determined based on an actual case.

A processing command waiting for calculation may be further determined based on the processing quantity, to avoid a problem that a large amount of calculation is performed within a short time, causing excessively high usage of computing resources.

Whether to spawn a virtual object may be further determined based on a time interval, to avoid a problem that a large amount of calculation is performed within a short time, causing excessively high usage of computing resources.

The second virtual object that has been spawned may be destroyed based on a distance between the main control virtual object and the second virtual object in the virtual environment. In this way, destroying of each virtual object around the main control virtual object can be separately and precisely controlled, to improve accuracy of displaying the virtual object. Even in a scenario in which virtual objects need to be frequently spawned, display effect of the virtual objects can be ensured, to improve interaction experience of an interaction object and further increase a human-computer interaction rate.

A status of the second processing command may be further switched when the second distance is greater than the second distance threshold, to provide a simple and convenient implementation of destroying a virtual object by using a processing command.

A manner of processing a processing command in an array may be further determined based on a status of the processing command, so that manners of processing different processing commands in the array can be quickly and accurately determined.

A processing command for a virtual object may be further managed by maintaining the command data set, so that a virtual object can be cyclically spawned and destroyed.

The debug information may be further displayed in different display styles, so that a developer can conveniently debug spawning and destroy commands.

A sequence of the operations of the method may be appropriately adjusted, and the operations may also be correspondingly added or deleted based on a situation. All variant methods readily ascertained by a person skilled in the art are not described in detail.

The method may be divided into refresh and destroy system initialization stage and a refresh command processing procedure stage.

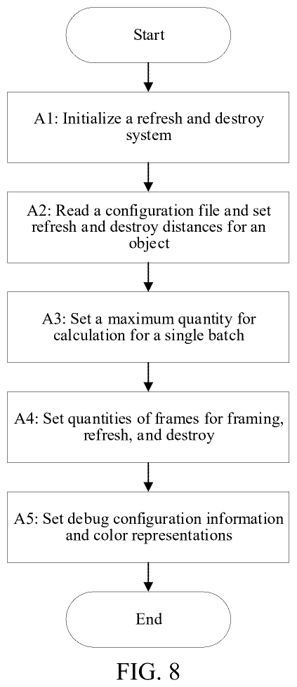

FIG. 8 is a schematic diagram of an initialization stage of a refresh and destroy system according to one or more aspects described herein. As shown in FIG. 8:

In operation A1, initialization of the refresh and destroy system may start. During the initialization of the refresh and destroy system, a computer device may read a configuration file of Refresh Actor Opt Config in Refresh Actor Settings, to set Refresh Actor Opt Config.

In operation A2, the computer device may read a configuration file of a system configuration, and may set refresh distances and destroy distances for different types of virtual objects. Spawn Opt Type for Refresh Actor Opt Config data may include eight types: Default Opt, Default NPC Opt, Default Item Opt, Cinematic NPC Opt, Cinematic Item Opt, Epic NPC Opt, Epic Item Opt, and Ignore Opt. Each type may correspond to a set of Spawn Distance and Destroy Distance.

In operation A3, the computer device may set, based on the system configuration, refresh calculation frequency, destroy calculation frequency, and/or a maximum quantity of refresh commands that can be processed in a single batch. For example, a configuration file of Clear Working Spawner Time in Refresh Actor Settings may be read, a value range of Clear Working Spawner Time (default configuration time is 0.3 s) may be set to 0-10, and an overall refresh command processing procedure may be performed at a time interval of Clear Working Spawner Time. Refresh Actor Settings may be read, a value range of Max Cal Num Frame (a default value is 10) is set to 0-100, and a command may perform calculation at an interval of Max Cal Num Frame.

In operation A4, the computer device may set, based on the system configuration, a refresh and destroy framing policy (refreshing/destroying at an interval of xx frames) for refreshing and destroying an object. For example, Refresh Actor Settings may be read, a value range of Max Frame Num To Spawn (a default value is 3) may be set to 0-10, and a virtual object may be really spawned at an interval of Max Frame Num To Spawn.

In operation A5, the computer device may initialize a debug information prompt based on the system configuration, and may display different color prompts and different text description prompts based on a debug configuration when a processing command is in different states, so that a user can better debug refresh and destroy commands. For example, Color Des Map information in a configuration file of Refresh Actor Settings may be read, corresponding description information is extracted from Color Des Map based on FColor::Red, FColor::Yellow, FColor::Green, FColor::White, FColor::Purple, and FColor::Blue, a correspondence between descriptions and colors may be established, and debug information may be initialized.

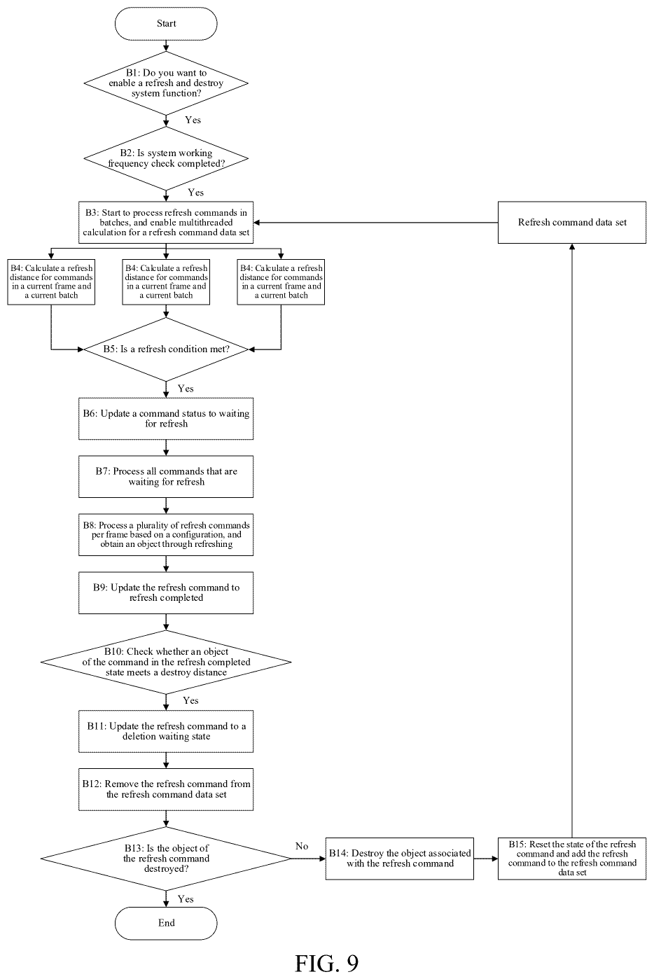

FIG. 9 is a schematic diagram of a refresh command processing procedure stage according to one or more aspects described herein. As shown in FIG. 9:

In operations B1 and B2, a computer device may begin to check a tick of a refresh and destroy system, determine whether the refresh and destroy system is enabled, and return if the system is not enabled. After the system is enabled, all command data sets (Cache Command Spawners Map) may be obtained, and the command data sets may be cyclically checked to determine whether a difference between a current quantity of system frames and a quantity of command calculation frames is greater than Max Cal Num Frame. If the difference between the current quantity of system frames and the quantity of command calculation frames is greater than Max Cal Num Frame, a processing command in the command data set may be added to a to-be-calculated array (Cache Command Spawners), to complete system working frequency check; otherwise, the command may be skipped in the frame.

In operations B3 to B6, the computer device may cyclically check the to-be-calculated array (Cache Command Spawners), enable multithreaded calculation to calculate a distance between a spawn location of a processing command and a location of a main control virtual object, determine whether the distance meets a refresh distance configuration for this type of processing command in Refresh Actor Opt Config (in other words, determines whether a refresh condition is met), and continue to check whether the spawn location is on the ground if the distance is less than the refresh distance configuration. If a virtual object corresponding to the processing command belongs to a type that ignores the ground check, the operation of checking whether the spawn location is on the ground may be skipped. If the virtual object corresponding to the processing command does not belong to a type that ignores the ground check, whether the spawn location is on the ground may be checked. After the check succeeds (to be specific, it is determined that the spawn location is on the ground), the processing command may be updated to a refresh waiting state, and the processing command may be added to an array waiting for spawning (Waiting Spawner Values).

In operations B7 to B9, the computer device cyclically may check the array waiting for spawning (Waiting Spawner Values), set a processing command to a spawn waiting state (ENGRC Spawn State::Waiting Spawn State), and add the processing command to an array being spawned (Working Spawner Map). The spawn waiting state may also be referred to as a refresh waiting state.

The computer device may cyclically check the array being spawned (Working Spawner Map), process a spawning command at an interval of Max Frame Num to Spawn, obtain a virtual object through refreshing, and set a processing command to a spawning completed state (ENGRC Spawn State::Finished Spawn State). The spawning completed state may also be referred to as a refresh completed state.

In operations B10 and B11, the computer device may cyclically check the array being spawned (Working Spawner Map) to determine whether a processing command is in a spawning completed state (ENGRC Spawn State::Finished Spawn State), and if the processing command is in the spawning completed state, may enable multithreaded calculation to determine, through calculation, whether a location of a virtual object corresponding to the processing command and a location of the main control virtual object meet a destroy distance. If the location of the virtual object corresponding to the processing command and the location of the main control virtual object meet the destroy distance, the processing command may be set to a destroy waiting state (ENGRC Spawn State::Waiting Destroy State). The destroy waiting state may also be referred to as a deletion waiting state.

In operations B12 to B15, the computer device may cyclically check the array being spawned (Working Spawner Map) to determine whether a processing command is in a destroy waiting state (ENGRC Spawn State::Waiting Destroy State). If the processing command is in the destroy waiting state (ENGRC Spawn State::Waiting Destroy State), the computer device may destroy a spawned virtual object corresponding to the processing command, and remove the processing command from the command data set. After the virtual object is destroyed, the computer device may call a RecoverDataForSpawnOpt( ) function to reset the processing command, and add the processing command to the command data set (Cache Command Spawners Map) again. In this way, a refresh command processing procedure is completed.

In a game of a big world map type, virtual objects are refreshed and destroyed all the time. In the method provided herein, refresh and destroy commands (processing commands) may be abstracted. After a large quantity of refresh and destroy commands are inputted to a system, destroy commands may be spawned through configuration of multi-frame processing, to reduce processor occupation at a single moment. A type of a virtual object of the refresh command may be determined based on a system optimization configuration, to determine conditions of a refresh distance and a destroy distance. When the conditions are met, the refresh and destroy commands may be automatically processed. In addition, simultaneous refreshing and destroying of virtual objects are no longer bottlenecks of a delay of a processor, and a plurality of objects can be smoothly spawned and destroyed. Overall processor occupation can be reduced, and memory usage is reduced.

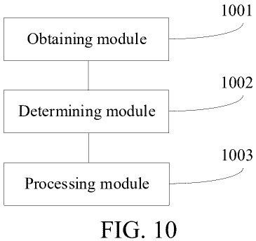

FIG. 10 is a schematic structural diagram of a virtual object spawning apparatus according to one or more aspects described herein. As shown in FIG. 10, the apparatus includes:
an obtaining module 1001, configured to obtain a first processing command, the first processing command corresponding to a first distance threshold and a spawn location, the first distance threshold being configured for triggering spawning of a first virtual object in a virtual environment, and the spawn location being a location configured for spawning the first virtual object in the virtual environment;
a determining module 1002, configured to determine a first distance between a main control virtual object and the spawn location; and
a processing module 1003, configured to process the first processing command in response to the first distance meeting the first distance threshold, to spawn the first virtual object in the virtual environment.

The determining module 1002 may be configured to:
determine that the first processing command is in a spawn waiting state in response to the first distance being less than the first distance threshold; and
the processing module 1003 may be configured to process the first processing command in the spawn waiting state to spawn the first virtual object in the virtual environment.

The determining module 1002 may be configured to:
add the first processing command to a to-be-spawned array in response to the first distance being less than the first distance threshold; and
set the first processing command in the to-be-spawned array to the spawn waiting state, and add the first processing command to an array being spawned; and
the processing module 1003 may be configured to:
process the first processing command in the spawn waiting state in the array being spawned.

The processing module 1003 may be configured to:
in response to an interval between a current quantity of frames and a first quantity of frames being greater than a first quantity of interval frames, process the first processing command in the spawn waiting state in the array being spawned,
the first quantity of frames being a quantity of frames when a virtual object is spawned in the virtual environment at a previous time.

The determining module 1002 may be further configured to:
determine the first quantity of interval frames based on at least one of a moving speed of the main control virtual object, a distance between a current location and a historical location of the main control virtual object, a behavior type of the main control virtual object, a virtual vehicle taken by the main control virtual object, environment information of the virtual environment, a behavior type of a virtual object that has been spawned in the virtual environment, a quantity of virtual objects that have been spawned in the virtual environment, or an estimated computing resource corresponding to a processing command in the spawn waiting state in the array being spawned,
the historical location being a location of the main control virtual object when the virtual object is spawned in the virtual environment at the previous time, and the estimated computing resource being configured for estimating a computing resource to be consumed for spawning a virtual object corresponding to the processing command in the spawn waiting state.

The determining module 1002 may be further configured to:
set the first processing command to a spawning completed state in response to completion of processing of the first processing command in the spawn waiting state in the array being spawned,
the first processing command in the spawning completed state in the array being spawned being configured for destroying the first virtual object in the virtual environment.

The obtaining module 1001 may be configured to:
obtain a command data set, the command data set being configured for storing a processing command corresponding to a virtual object that has not been spawned in the virtual environment;
determine a to-be-calculated processing command from the command data set;
add the to-be-calculated processing command to a to-be-calculated array; and
obtain the first processing command from the to-be-calculated array.

The obtaining module 1001 may be configured to:
determine the to-be-calculated processing command from the command data set in response to an interval between the current quantity of frames and a second quantity of frames being greater than a second quantity of interval frames,
the second quantity of frames being a quantity of frames when a to-be-calculated processing command is determined from the command data set at a previous time.

The determining module 1002 may be further configured to:
determine the second quantity of interval frames based on at least one of a quantity of processing commands in the command data set, the moving speed of the main control virtual object, or the quantity of virtual objects that have been spawned in the virtual environment.

The obtaining module 1001 may be configured to:
determine to-be-calculated processing commands whose quantity is not greater than a processing quantity from the command data set.

In an exemplary design, the processing module 1003 may be further configured to:
in response to a current moment meeting a period indicated by a time interval, determine, in a multithreaded manner, whether to process the to-be-calculated processing command in the to-be-calculated array.

The obtaining module 1001 may be further configured to:
obtain a second processing command, the second processing command corresponding to a second distance threshold, and the second distance threshold being configured for triggering destroying of a second virtual object that has been spawned in the virtual environment;
the determining module 1002 may be further configured to determine a second distance between the main control virtual object and the second virtual object; and
the processing module 1003 may be further configured to process the second processing command in response to the second distance meeting the second distance threshold, to destroy the second virtual object in the virtual environment.

The determining module 1002 may be configured to:
determine that the second processing command is in a destroy waiting state in response to the second distance being greater than the second distance threshold; and
the processing module 1003 may be configured to process the second processing command in the destroy waiting state to destroy the second virtual object in the virtual environment.

The obtaining module 1001 may be configured to:
obtain the second processing command from processing commands in a spawning completed state in the array being spawned; and
the processing module 1003 may be configured to process the second processing command in the destroy waiting state in the array being spawned,
the array being spawned being configured for storing at least one of a processing command corresponding to a virtual object that has been spawned in the virtual environment and a processing command corresponding to a virtual object that is waiting to be destroyed, and the processing command in the spawning completed state being a processing command corresponding to the virtual object that has been spawned.

The determining module 1002 may be further configured to:
in response to completion of processing of the second processing command in the destroy waiting state in the array being spawned, reset the second processing command, and add the second processing command to the command data set,
the command data set being configured for storing a processing command corresponding to a virtual object that has not been spawned in the virtual environment.

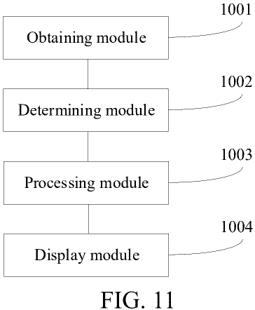

As shown in FIG. 11, the apparatus further includes:
a display module 1004, configured to: display a debug interface, the debug interface displaying at least the virtual environment and the main control virtual object,
the display module 1004 being configured to display debug information on the debug interface based on a debug configuration,
the debug information being configured for indicating a processing status of the first processing command, a display style of the debug information varying in different processing statuses, and the debug configuration being configured for indicating the display style.

The obtaining module 1001 may be further configured to:
obtain a system configuration, the system configuration including first distance thresholds respectively corresponding to a plurality of types of virtual objects.

The virtual object spawning apparatus is described with an example of division of the foregoing functional modules. During actual application, the functions may be allocated to and completed by different functional modules according to requirements, that is, the internal structure of the device may be divided into different functional modules, to implement all or some of the functions described above. The virtual object spawning apparatus provided herein may implement any combination of the processes described in reference to the virtual object spawning method described above, the details of which are not repeated here.

A computer device is also provided herein. The computer device may include a processor and a memory. The memory may have at least one program stored therein. The at least one program may be loaded and executed by the processor, to enable the computer device to implement the virtual object spawning method provided herein.

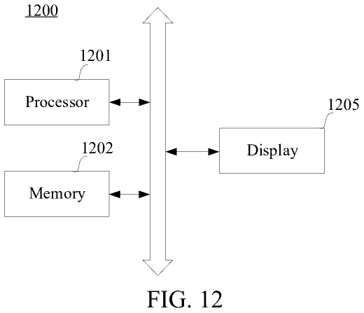

For example, the computer device may be a terminal. FIG. 12 is a schematic structural diagram of a terminal according to one or more aspects described herein.

The terminal 1200 may include a processor 1201 and a memory 1202.

The processor 1201 may include one or more processing cores, for example, a 4-core processor or an 8-core processor. The processor 1201 may be implemented in at least one hardware form of a digital signal processor (DSP), a field-programmable gate array (FPGA), and a programmable logic array (PLA). The processor 1201 may also include a main processor and a coprocessor. The main processor is a processor configured to process data in an awake state, and is also referred to as a central processing unit (CPU). The coprocessor is a low-power processor configured to process data in a standby state. The processor 1201 may be integrated with a graphics processing unit (GPU). The GPU is configured to render and draw content that needs to be displayed on a display. The processor 1201 may further include an artificial intelligence (AI) processor. The AI processor may be configured to process computing operations related to machine learning.

The memory 1202 may include one or more computer-readable storage media. The computer-readable storage medium may be non-transitory. The memory 1202 may further include a high-speed random access memory and a non-volatile memory, for example, one or more disk storage devices or flash storage devices. The non-transitory computer-readable storage medium in the memory 1202 may be configured to store at least one instruction. The at least one instruction may be executed by the processor 1201, to enable the terminal 1200 to implement the virtual object spawning method provided herein.

The terminal 1200 further includes a display 1205.

The display 1205 may be configured to display a user interface (UI). The UI may include a graph, text, an icon, a video, and any combination thereof. When the display 1205 is a touch display, the display 1205 further has a capability of capturing a touch signal on or above a surface of the display 1205. The touch signal may be inputted to the processor 1201 as a control signal for processing. In this case, the display 1205 may be further configured to provide a virtual button and/or a virtual keyboard, also referred to as a soft button and/or a soft keyboard. There may be one display 1205 disposed on a front panel of the terminal 1200. There may be at least two displays 1205 respectively disposed on different surfaces of the terminal 1200 or designed in a folded form. The display 1205 may be a flexible display disposed on a curved surface or a folded surface of the terminal 1200. The display 1205 may alternatively be disposed in a non-rectangular irregular pattern, namely, a special-shaped screen. The display 1205 may be made of a liquid crystal display (LCD), an organic light-emitting diode (OLED), or other materials. For example, the debug interface, the system configuration interface, and the like are displayed on the display 1205.

A person skilled in the art may understand that the structure shown in FIG. 12 constitutes no limitation on the terminal 1200, and the terminal may include more or fewer components than those shown in the figure, or some components may be combined, or different component layouts may be used.

A non-volatile, non-transitory computer-readable storage medium. The non-volatile, non-transitory computer-readable storage medium has at least one program stored therein. When the at least one program is loaded and executed by a processor of a computer device, the virtual object spawning method provided herein may be implemented.

A computer program product and/or a computer program is also provided herein. The computer program product or the computer program includes computer instructions, and the computer instructions are stored in a non-transitory computer-readable storage medium. A processor of a computer device reads the computer instructions from the non-transitory computer-readable storage medium, and the processor executes the computer instructions to enable the computer device to perform the virtual object spawning method provided herein.

A person of ordinary skill in the art may understand that all or some of the operations described herein may be implemented by hardware, or may be implemented by a program instructing relevant hardware. The program may be stored in a non-volatile, non-transitory computer-readable storage medium. The non-volatile, non-transitory computer-readable storage medium may be a read-only memory, a magnetic disk, a compact disc, or the like.

The foregoing descriptions are merely exemplary and are not intended to limit the scope. Any modification, equivalent replacement, or improvement made within the principle described herein shall fall within the protection scope.

What is claimed is:

1. A method comprising:
obtaining a first processing command, the first processing command corresponding to a first distance threshold and a spawn location, the first distance threshold indicating a triggering condition for spawning of a first virtual object in a virtual environment, and the spawn location indicating a location for spawning the first virtual object in the virtual environment;
determining a first distance between a main control virtual object and the spawn location; and
spawning the first virtual object in the virtual environment by processing the first processing command, wherein the spawning is based on a determination that the first distance meets the first distance threshold.

2. The method according to claim 1, wherein the spawning comprises:
determining that the first processing command is in a spawn waiting state based on the determination that the first distance is less than the first distance threshold; and
processing the first processing command in the spawn waiting state to spawn the first virtual object in the virtual environment.

3. The method according to claim 2, wherein:
the determining that the first processing command is in a spawn waiting state based on the determination that the first distance is less than the first distance threshold comprises:
adding the first processing command to a to-be-spawned array;
setting the first processing command in the to-be-spawned array to the spawn waiting state; and
adding the first processing command to an array being spawned; and
the processing the first processing command in the spawn waiting state comprises:
processing the first processing command in the spawn waiting state in the array being spawned.

4. The method according to claim 3, wherein the processing the first processing command in the spawn waiting state in the array being spawned comprises:
based on a determination that an interval between a current quantity of frames and a first quantity of frames is greater than a first quantity of interval frames, processing the first processing command in the spawn waiting state in the array being spawned,
wherein the first quantity of frames is a quantity of frames when a different virtual object is spawned in the virtual environment at a previous time.

5. The method according to claim 4, wherein the method further comprises:
determining the first quantity of interval frames based on at least one of a moving speed of the main control virtual object, a distance between a current location and a historical location of the main control virtual object, a behavior type of the main control virtual object, a virtual vehicle taken by the main control virtual object, environment information of the virtual environment, a behavior type of a virtual object that has been spawned in the virtual environment, a quantity of virtual objects that have been spawned in the virtual environment, or an estimated computing resource corresponding to a processing command in the spawn waiting state in the array being spawned,
the historical location being a location of the main control virtual object when the virtual object is spawned in the virtual environment at the previous time, and the estimated computing resource estimating a computing resource to be consumed for spawning a virtual object corresponding to the processing command in the spawn waiting state.

6. The method according to claim 4, wherein the method further comprises:
setting the first processing command to a spawning completed state in response to completion of processing of the first processing command in the spawn waiting state in the array being spawned, wherein the first processing command in the spawning completed state in the array being spawned destroys the first virtual object in the virtual environment.

7. The method according to claim 1, wherein the obtaining a first processing command comprises:
obtaining a command data set that stores a processing command corresponding to a second virtual object that has not been spawned in the virtual environment;
determining a to-be-calculated processing command from the command data set;
adding the to-be-calculated processing command to a to-be-calculated array; and
obtaining the first processing command from the to-be-calculated array.

8. The method according to claim 7, wherein the determining a to-be-calculated processing command from the command data set comprises:
determining the to-be-calculated processing command from the command data set in response to an interval between a current quantity of frames and a second quantity of frames being greater than a second quantity of interval frames,
the second quantity of frames being a quantity of frames when a to-be-calculated processing command is determined from the command data set at a previous time.

9. The method according to claim 8, wherein the method further comprises:
determining the second quantity of interval frames based on at least one of a quantity of processing commands in the command data set, a moving speed of the main control virtual object, or the quantity of virtual objects that have been spawned in the virtual environment.

10. The method according to claim 7, wherein the determining a to-be-calculated processing command from the command data set comprises: determining to-be-calculated processing commands whose quantity is not greater than a processing quantity from the command data set.

11. The method according to claim 10, wherein the method further comprises:
in response to a current moment meeting a period indicated by a time interval, determining, in a multithreaded manner, whether to process the to-be-calculated processing command in the to-be-calculated array.

12. The method according to claim 1, wherein the method further comprises:
obtaining a second processing command, the second processing command corresponding to a second distance threshold for triggering destroying of a second virtual object that has been spawned in the virtual environment;
determining a second distance between the main control virtual object and the second virtual object; and
destroying the second virtual object in the virtual environment by processing the second processing command based on a determination that the second distance meets the second distance threshold.

13. The method according to claim 12, wherein the destroying comprises:
determining that the second processing command is in a destroy waiting state based on a determination that the second distance is greater than the second distance threshold; and
destroying the second virtual object in the virtual environment by processing the second processing command in the destroy waiting state.

14. An apparatus comprising:
one or more processors; and
memory storing computer-readable instructions that when executed by the one or more processors, cause the apparatus to:
obtain a first processing command, the first processing command corresponding to a first distance threshold and a spawn location, the first distance threshold indicating a triggering condition for spawning of a first virtual object in a virtual environment, and the spawn location indicating a location for spawning the first virtual object in the virtual environment;
determine a first distance between a main control virtual object and the spawn location; and
spawn the first virtual object in the virtual environment by processing the first processing command, wherein the spawning is based on a determination that the first distance meets the first distance threshold.

15. The apparatus according to claim 14, wherein the spawning comprises:
determining that the first processing command is in a spawn waiting state based on the determination that the first distance is less than the first distance threshold; and
processing the first processing command in the spawn waiting state to spawn the first virtual object in the virtual environment.

16. The apparatus according to claim 15, wherein:
the determining that the first processing command is in a spawn waiting state based on the determination that the first distance is less than the first distance threshold comprises:
adding the first processing command to a to-be-spawned array;
setting the first processing command in the to-be-spawned array to the spawn waiting state; and
adding the first processing command to an array being spawned; and
the processing the first processing command in the spawn waiting state comprises:
processing the first processing command in the spawn waiting state in the array being spawned.

17. The apparatus according to claim 16, wherein the processing the first processing command in the spawn waiting state in the array being spawned comprises:
based on a determination that an interval between a current quantity of frames and a first quantity of frames is greater than a first quantity of interval frames, processing the first processing command in the spawn waiting state in the array being spawned,
wherein the first quantity of frames is a quantity of frames when a different virtual object is spawned in the virtual environment at a previous time.

18. The apparatus according to claim 16, the memory storing computer-readable instructions that when executed by the one or more processors, cause the apparatus to:
set the first processing command to a spawning completed state in response to completion of processing of the first processing command in the spawn waiting state in the array being spawned, wherein the first processing command in the spawning completed state in the array being spawned destroys the first virtual object in the virtual environment.

19. The apparatus according to claim 14, wherein the obtaining a first processing command comprises:
obtain a command data set that stores a processing command corresponding to a second virtual object that has not been spawned in the virtual environment;
determine a to-be-calculated processing command from the command data set;
add the to-be-calculated processing command to a to-be-calculated array; and
obtain the first processing command from the to-be-calculated array.

20. A non-transitory computer-readable storage medium storing instructions that when executed by one or more processors, cause the one or more processors to:
obtain a first processing command, the first processing command corresponding to a first distance threshold and a spawn location, the first distance threshold indicating a triggering condition for spawning of a first virtual object in a virtual environment, and the spawn location indicating a location for spawning the first virtual object in the virtual environment;
determine a first distance between a main control virtual object and the spawn location; and
spawn the first virtual object in the virtual environment by processing the first processing command, wherein the spawning is based on a determination that the first distance meets the first distance threshold.
